(19) United States
(12) Patent Application Publication
(10) Pub. No.: US 2025/0147241 A1
(43) Pub. Date: May 8, 2025

(54) WATERPROOF OPTICAL CONNECTOR

(71) Applicant: NWC CO., LTD, Gunpo-si, Gyeonggi-do (KR)

(72) Inventors: Keun Hwan KIM, Seoul (KR); Ju Ho LEE, Suwon-si (KR); Jun Youl LEE, Seoul (KR)

(21) Appl. No.: 18/837,836

(22) PCT Filed: Feb. 14, 2023
(86) PCT No.: PCT/KR2023/002117

§ 371 Date: Aug. 12, 2024

(30) Foreign Application Priority Data
Feb. 15, 2022 (KR) 10-2022-0019464

(51) Int. Cl. G02B 6/38

(52) U.S. Cl. CPC G02B 6/3816; G02B 6/3893

(57) ABSTRACT

Disclosed is a waterproof optic connector. The waterproof optic connector includes a fixing unit in which a connection part connected to a first member of a socket is disposed, a movable unit that is combined with a part of the fixing unit and that is movable, and an elastic part that applies an elastic force to the movable unit so that the movable unit becomes distant from the first member. The movable unit may have a location set by moving in a straight line toward the first member by the pressurization of the second member combined with the first member.

### CROSS-REFERENCE TO RELATED APPLICATION

This application is based on and claims priority under 35 U.S.C. 119 to Korean Patent Application No. 10-2022-0019464, filed on Feb. 15, 2022 in the Korean intellectual property office, the disclosures of which are herein incorporated by reference in their entireties.

### TECHNICAL FIELD

The present disclosure relates to a waterproof optic connector.

### BACKGROUND OF THE DISCLOSURE

An optical signal transmission technology is a technology in which information is transmitted on a transmission path in an optical signal form, among wired transmission technologies. A wired optical signal transmission technology using an optical fiber line made of glass is commonly used as the optical signal transmission technology for short/long distance high-capacity transmission. The wired optical transmission technology is a multi-transmission technology using one optical line like several independent lines by using physical characteristics of light.

A transmission terminal for optical communication converts an electrical signal into an optical signal and transmits the optical signal through an optical fiber line. A reception terminal converts the optical signal into the electrical signal again. A signal conversion module to which the optical fiber line is connected is disposed in each of the transmission terminal and the reception terminal.

The signal conversion module is disposed within a terminal box. A socket to which the optical fiber line is connected is disposed in the terminal box.

Referring to FIG. 11, a socket S includes a first member S1 that is combined with a terminal box and to which a connector 1a of an optical fiber line is connected and a second member S2 that protects the first member S1 against an external factor, such as rainwater or dust.

A part of the connector 1a is inserted into the first member S1 and connected thereto. The second member S2 is combined with the first member S1 while surrounding and protecting the other part of the connector 1a that is exposed in the first member S1. The length of the connector 1a that is inserted into the first member S1 may be different depending on a combination location of the first member S1. If a part of the connector 1a is not inserted into the first member S1 by a set value, there is a problem in that the second member S2 is not fully combined with the first member S1. Accordingly, waterproofness is reduced because rainwater or dust flows into the socket S.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

An embodiment of the present disclosure provides a waterproof optic connector having improved waterproofness because the coupling force of a socket is increased due to a movement of a movable unit when the end of a connector disposed within the socket, which has a fixing unit and the movable unit, is combined with the socket.

A waterproof optic connector according to an embodiment of the present disclosure includes a fixing unit in which a connection part connected to a first member of a socket is disposed, a movable unit that is combined with a part of the fixing unit and that is movable, and an elastic part that applies an elastic force to the movable unit so that the movable unit becomes distant from the first member.

The movable unit may have a location set by moving in a straight line toward the first member by the pressurization of the second member combined with the first member.

The fixing unit may include a ratchet part in which a connection part is disposed, and a guide part that protrudes in a direction opposite to the direction of the connection part from the ratchet part and with which the movable unit is movably combined.

A travel gear space through which an optical fiber connected to the connection part passes may be formed in the ratchet part between the guide part and the connection part. An optical fiber passage connected to the travel gear space may be formed within the guide part.

A seated groove in which the guide part may be separably disposed is formed in the ratchet part.

The fixing unit may further include a binding part that prevents a movement of the guide part by binding the guide part with the ratchet part.

The guide part may include a guide body that protrudes from the ratchet part and a flange formed in an outer circumference of the guide body and separated from the ratchet part.

A cross section of the optical fiber passage may be increased toward the ratchet part on the basis of the flange.

The movable unit may include a top junction that is combined with the guide body so that the top junction moves in a straight line and that is trapped at the flange and an inner junction that is combined with the top junction and faces the flange and an inside of which is penetrated.

The movable unit may be movable in a straight line between the flange and the ratchet part. The elastic part may be disposed between the flange and the inner junction and may apply the elastic force so that the top junction is trapped at the flange.

A guide groove through which the guide body penetrates may be formed in the top junction in a polygon shape. A rail and a rail groove that provide guidance to a movement of the top junction in a straight line may be formed in the guide body and the circumference of the guide groove.

The outer circumference of the flange may come into contact with an inner circumference of the top junction. A part of each of the outer circumference of the flange and the inner circumference of the top junction may include a plane. The plane may provide guidance to the movement of the top junction in the straight line.

The outer circumference of the flange may come into contact with the inner circumference of the top junction. A rail and a rail groove that provide guidance to a movement of the top junction in a straight line may be formed in the inner circumference of the top junction and the outer circumference of the flange.

The movable unit may further include a sheath that protects the movable unit and the optical fiber connected to the connection part, and a connection part that is combined with the top junction.

The connection part may include a rivet that is inserted into the sheath from the inner junction, a clamping tube that surrounds and combines the sheath and the rivet, a sealing tube that is connected to the top junction and that surrounds and protects a connection portion of the rivet and the sheath, and a boot that is combined with the sealing tube and that surrounds the sheath.

The connection part may further include a bottom tube that is closely attached to the inner junction and the clamping tube by the pressurization of the sealing tube within the sealing tube, and a junction sealing member that is disposed between the inner circumference of the sealing tube and the outer circumference of the sheath.

The connection part may further include a bottom combination part that combines the bottom tube and the inner junction with a gap.

The gap may enable the sealing tube to be offset by the combination of the top junction, so that the bottom combination part is closely attached to the clamping tube.

The movable unit may further include a first protection tube that protrudes from the guide body toward the inner junction and a second protection tube that protrudes from the inner junction toward the first protection tube and that is connected to the first protection tube.

The optical fiber of the sheath passes through an inside of the guide body, through the second protection tube and an inside of the first protection tube.

According to an embodiment of the present disclosure, the coupling force of the socket is increased because the movable unit is moved along the second member when the second member and first member of the socket are combined.

According to an embodiment of the present disclosure, due to a movement of the top junction, the inner junction pressurizes the elastic part, and the second protection tube is gradually inserted into the first protection tube. Accordingly, the optical fiber can be safely protected without being bent when the top junction is moved because the optical fiber is not exposed to the slide space.

According to an embodiment of the present disclosure, the guide part is combined with the ratchet part, and the top junction is moved in a straight line by the guide part. The top junction that is moved to the travel gear space of the ratchet part in a straight line does not enter the travel gear space. Accordingly, optical fiber arrangement efficiency of the travel gear space is improved, and the optical fiber is not damaged.

According to an embodiment of the present disclosure, the bottom tube is combined with the inner junction with a gap through the bottom combination part. Accordingly, the bottom tube is combined with the inner junction without being influenced by a combination location of the clamping tube. Furthermore, there is an effect in that airtightness is maintained because the bottom tube is closely attached to the inner junction by the pressurization of the sealing tube.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

### DETAILED DESCRIPTION

While illustrative embodiments have been illustrated and described, it will be appreciated that various changes can be made therein without departing from the spirit and scope of the disclosure.

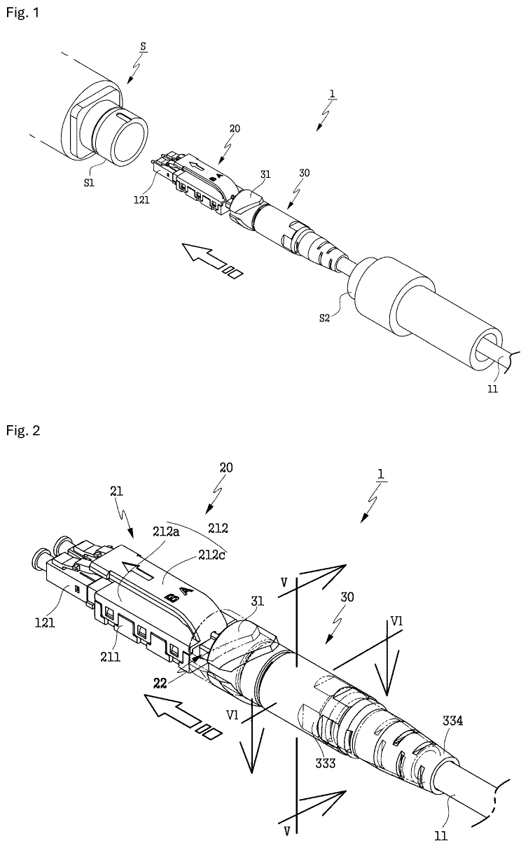

A waterproof optic connector according to an embodiment of the present disclosure is first described with reference to FIGS. 1 to 7.

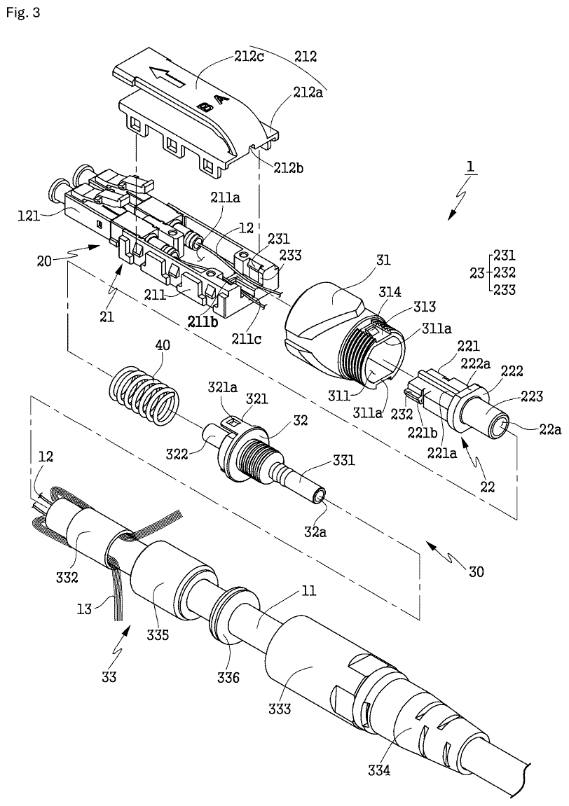

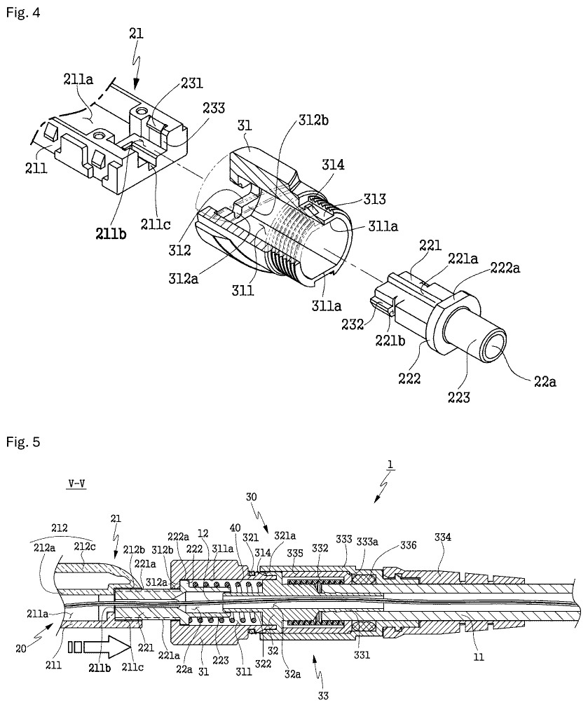

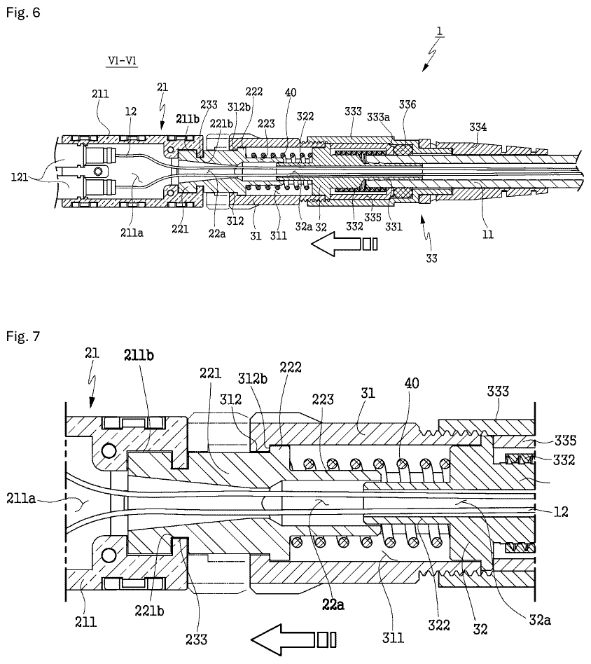

FIG. 1 is a diagram illustrating the state in which the waterproof optic connector according to an embodiment of the present disclosure is used. FIG. 2 is an enlarged view of the waterproof optic connector of FIG. 1. FIG. 3 is an exploded view of FIG. 2. FIG. 4 is an exploded view of a fixing unit and a movable unit in FIG. 1. FIG. 5 is a cross-sectional view taken along line V-V in FIG. 2. FIG. 6 is a cross-sectional view taken along line VI-VI in FIG. 2. FIG. 7 is an enlarged view of the fixing unit and the movable unit in FIG. 6.

Referring to FIGS. 1 to 7, the waterproof optic connector 1 according to the present embodiment includes a fixing unit 20, a movable unit 30, and an elastic part 40. The coupling force of the waterproof optic connector is increased due to a movement of the movable unit 30 when a socket in which the waterproof optic connector 1 is received is combined.

The fixing unit 20 includes a ratchet part 21 and a guide part 22. A connection part 121 of an optical fiber 12 is mounted on the fixing unit 20 and may protrude therefrom. A part of the fixing unit 20 may be inserted into a first member S1 a socket S that is combined with a terminal box. The fixing unit 20 may further include a binding part 23.

The ratchet part 21 includes a base 211 and a cover 212, and protects and fixes the connection part 121.

The base 211 and the cover 212 are combined in a way to be separable from each other. A travel gear space 211a through which the optical fiber 12 passes is formed in the base 211. The connection part 121 that is connected to the optical fiber and connected to a signal conversion module may be disposed at one end of the base 211. The connection part 121 may be an LC type connector of a known optical cable, but the connection part 121 is not limited to the LC type connector.

One end of the connection part 121 may protrude from the base 211 for a connection with the first member S1, and the other end thereof is disposed within the base 211. A trapping groove and a trapping jaw that prevent a movement of the connection part 121 in a length direction thereof are formed between the outer circumference of the connection part 121 and the inner circumference of the base 211 so that the connection part 121 is not detached from the base 211.

A seated groove 211b connected to the travel gear space 211a is formed at the other end of the base 211. The size of the width of the seated groove 211b is smaller than the size of the width of the travel gear space 211a. A rail groove 211c is formed at the center of the bottom of the seated groove 211b in a length direction thereof.

The cover 212 includes a cover body 212a and a ratchet 212c, protects the optical fiber of the travel gear space 211a, and protects the lever of the connection part 121 against an external factor.

The cover body 212a is disposed at the open top of the base 211, and is separably combined by a trapping protrusion and a trapping groove. A rail groove 212b corresponding to the rail groove 211c of the seated groove 211b is formed in a length direction thereof at the center of the bottom of the cover body 212a on the other side thereof.

The ratchet 212c is bent from the other end of the top of the cover body 212a to one end thereof, and covers the lever of the connection part 121. When an external force is applied to the ratchet 212c, the connection part 121 can be separated from the first member S1 as the lever of the connection part 121 connected to the first member S1 is pressed.

The guide part 22 includes a guide body 221 and a flange 222, and provides guidance to a movement of the movable unit 30. The guide part 22 may further include a first protection tube 223. The guide body 221 and the first protection tube 223 are integrally formed. The flange 222 is disposed between the guide body 221 and the first protection tube 223.

One end of the guide body 221 is separably seated in the seated groove 211b, and the other end thereof protrudes from the ratchet part 21. Rails 221a that are inserted into the rail grooves 211c and 212b are formed at the centers of the top and bottom of the guide body 221 at one end thereof, respectively. The rail 221a is formed in the length direction of the guide body 221. A shape that is viewed from the front of the guide body 221 has a polygon. The guide body 221 is formed in a rectangular shape.

The flange 222 protrudes from the end of the guide body 221 to the outer circumference thereof. The flange 222 is formed in a circular shape, but h as two planes 222a because a part of each of the top and bottom of the flange is removed. The flange 222 faces the ratchet part 21 by being spaced apart from the ratchet part at a preset interval.

The first protection tube 223 protrudes in a cylindrical shape from the other end of the guide body 221.

An optical fiber passage 22a is formed within the guide part 22 in a length direction thereof. The optical fiber 12 that is connected to the connection part 121 may pass through the optical fiber passage 22a. In the state in which the guide part 22 has been cut on the plane, a portion of the optical fiber passage 22a, which is formed within the first protection tube 223 on the basis of the flange 222, has the same cross section, and a portion of the optical fiber passage 22a, which is formed within the guide body 221 on the basis of the flange 222, has a cross section that is gradually increased from the flange 222 to the ratchet part 21.

The binding part 23 includes a trapping member 231, a protrusion member 232, and a stopper member 233, and fixes the guide part 22 so that the guide part 22 is not moved in the ratchet part 21.

The trapping member 231 protrudes from an upper part of the seated groove 211b on both sides thereof to the guide body 221. The top of the trapping member 231 has an inclined surface.

The protrusion member 232 protrudes from a lower part of the guide body 221 at one end thereof to the outside. The bottom of the protrusion member 232 has an inclined surface that corresponds to the top of the trapping member 231. When one end of the guide body 221 is seated in the seated groove 211b, the bottom of the protrusion member 232 and the top of the trapping member 231 are brought into contact with each other and seated. The top of the protrusion member 232 is trapped at the bottom of the trapping member 231 and fixed thereto. Accordingly, the guide part 22 is not moved in up and down directions in the ratchet part 21.

The stopper member 233 is formed in up and down directions on both sides of the seated groove 211b, protrudes toward the guide body 221, and is inserted into the guide body 221. Accordingly, a stopper groove 221b at which the stopper member 233 is inserted and trapped in up and down directions is formed on both sides of the guide body 221. The guide part 22 is not moved in the length direction of the ratchet part 21 by the combination of the stopper member 233 and the stopper groove 221b.

By the combination of the binding part 23, the guide part 22 is not moved in the ratchet part 21. Furthermore, the guide part 22 is not rotated around its axis by a contact between the circumference of the seated groove 211b and the outer circumference of the guide body 221.

An example in which the guide part 22 and the ratchet part 21 are combined to have a separable structure has been described, but the guide part 22 and the ratchet part 21 may be integrally formed and not be separated from each other depending on the design of the waterproof optic connector 1.

The movable unit 30 includes a top junction 31 and an inner junction 32, and is movably combined with the fixing unit 20. The movable unit 30 may further include a second protection tube 322 and a connection part 33.

A slide space 311 in which the guide part 22 is disposed is formed within the top junction 31. The slide space 311 is opened toward the top junction 31 on the other side thereof. A guide groove 312 through which the guide body 221 penetrates is formed within the top junction 31 on one side thereof. The circumference of the guide groove 312 is formed in the polygon shape that corresponds to the guide body 221. A rail groove 312a with which the rail 221a is combined is formed in the circumference of the guide groove 312. A flange trapping jaw 312b is formed within the top junction 31 on one side thereof due to a difference between the diameter of the slide space 311 and upper and lower widths of the guide groove 312.

The circumference of the slide space 311 is formed to correspond to the outer circumference of the flange 222. Accordingly, a plane 311a corresponding to the plane 222a of the flange 222 is formed in the circumference of the slide space 311 in a length direction thereof.

A gap is formed between the circumference of the guide groove 312 and the outer circumference of the guide body 221. A movement of the top junction 31 that is moved is restricted when the flange trapping jaw 312b is trapped at the ratchet part 21 or the flange 222 in the moving direction of top junction 31. Accordingly, the top junction 31 may be moved between the flange 222 and the ratchet part 21.

The outer circumference of the top junction 31 on one side thereof is formed in multiple stages, and may be trapped at the inner circumference of the second member S2 of the socket S. As the second member S2 is combined with the first member S1, the top junction 31 can be moved in a straight line.

A screw is formed in the outer circumference of the top junction 31 on the other side thereof in the circumferential direction of the top junction 31. A part of the outer circumference of the top junction 31 on the other side thereof is formed to have a plane 313. The plane 313 does not include a screw, and an inner trapping jaw 314 protrudes therefrom. The top of the inner trapping jaw 314 has an inclined surface. The plane 313 and the inner trapping jaw 314 are formed in a plural number at intervals in the circumferential direction of the top junction 31.

The top junction 31 may be moved in a straight line without rotating in the circumferential direction thereof, when being moved by the guide groove 312 and the guide body 221 that each have the polygon and that come into contact with each other and the planes 222a and 311a. Accordingly, the straightness of the top junction 31 is improved.

The inner junction 32 is disposed on the other side of the top junction 31. A part of the inner junction 32 is inserted into the slide space 311, and faces the flange 222 and the first protection tube 223. A combination wing 321 that protrudes toward the top junction 31 and that comes into contact with the plane 313 protrudes on one side of the inner junction 32. A trapping groove 321a is formed in the combination wings 321. The combination wings 321 may overstride the inclined surface of the inner trapping jaw 314. As the inner trapping jaw 314 is trapped at the trapping groove 321a, the inner junction 32 maintains the state in which the inner junction 32 has been combined with the other side of the top junction 31. Accordingly, the inner junction 32 may move in a straight line along the top junction 31 that moves in the straight line.

The second protection tube 322 protrudes toward the flange 222 on one side of the inner junction 32 that faces the first protection tube 223, and is disposed in the slide space 311. The second protection tube 322 is inserted into the optical fiber passage 22a of the first protection tube 223. There is a gap between the outer circumference of the second protection tube 322 and the inner circumference of the first protection tube 223. When the top junction 31 moves from the flange 222 to the ratchet part 21 in a straight line, the second protection tube 322 may be gradually inserted into the first protection tube 223.

A guide passage 32a that is connected to the optical fiber passage 22a in a length direction thereof is formed within the inner junction 32. Accordingly, the optical fiber 12 that is connected to the connection part 121 may enter the optical fiber passage 22a through the guide passage 32a.

The optical fiber 12 is not exposed to the slide space 311 because the second protection tube 322 is inserted into the first protection tube 223. Accordingly, when the top junction 31 moves in a straight line, a problem, such as the bending of the optical fiber 12, does not occur.

The elastic part 40 is disposed in the slide space 311, and has one end coming into contact with the flange 222 while surrounding the outer circumference of the first protection tube 223 at an interval. The elastic part 40 has the other end coming into contact with the inner junction 32 while surrounding the outer circumference of the second protection tube 322 at an interval. The elastic force of the elastic part 40 enables the inner junction 32 to be moved in a direction that becomes distant from the flange 222. The top junction 31 that is connected to the inner junction 32 is also moved by the elastic force of the elastic part 40. At this time, the top junction 31 is detached from the ratchet part 21 and maintains the state in which the flange trapping jaw 312b comes into contact with the flange 222.

When an external force is applied to the top junction 31 toward the ratchet part 21, the top junction 31 is detached from the flange 222, and may be forward moved toward the ratchet part 21. The elastic part 40 may be pressurized and compressed by the inner junction 32. When the external force that pressurizes the top junction 31 is removed, the top junction 31 is backward moved by the elastic force of the elastic part 40, and the flange trapping jaw 312b is brought into contact with and trapped at the flange 222.

The connection part 33 includes a rivet 331, a clamping tube 332, a sealing tube 333, and a boot 334, and connects a sheath 11 that protects the optical fiber 12 and the top junction 31. The connection part 33 may further include a bottom tube 335 and a junction sealing member 336. The sheath 11 protects the optical fiber 12, an aramid fiber, etc. which are disposed therein.

The rivet 331 protrudes from the other side of the inner junction 32. The guide passage 32a penetrates the rivet 331. The rivet 331 is formed integrally with the inner junction 32 and is not detached from the inner junction 32. A part of the rivet 331 on the other side thereof is inserted into the sheath 11. One side of the rivet 331 is exposed to the outside of the sheath 11. The optical fiber 12 of the sheath 11 is connected to the connection part 121 through the guide passage 32a, the optical fiber passage 22a, and the travel gear space 211a. Furthermore, the aramid fiber 13 is exposed to the outside of the sheath 11 between the outer circumference of the rivet 331 and the inner circumference of the sheath 11.

The clamping tube 332 is disposed on the outer circumference of the sheath 11 where the rivet 331 is disposed. A part of the rivet 331 comes into contact with the inside of the clamping tube 332 on one side thereof. The other side of the clamping tube 332 pressurizes the sheath 11 toward the rivet 331. The sheath 11 and the rivet 331 are combined by the coupling force of the clamping tube 332.

Furthermore, the aramid fiber 13 that is exposed to the outside of the sheath 11 passes between the clamping tube 332 and the sheath 11, and is fixed by the clamping tube 332.

The inside of the sealing tube 333 is penetrated in a length direction thereof. The sealing tube 333 is disposed outside the clamping tube 332, and surrounds the sheath 11 and the clamping tube 332. A screw is formed within the sealing tube 333 on one side thereof. The screw is combined with the other side of the top junction 31. The other side of the sealing tube 333 is formed to have multiple stages. A plurality of short jaws 333a is formed within the sealing tube 333 on the other side thereof.

The boot 334 surrounds the sheath 11, and is combined with the other side of the sealing tube 333 by protrusions and grooves. The boot 334 fixes the end of the sheath 11 so that the sheath 11 is not bent.

The bottom tube 335 is disposed within the sealing tube 333, and surrounds the outside of the clamping tube 332. The bottom tube 335 may be moved in the state in which the sealing tube 333 and the top junction 31 have already been combined. However, when the sealing tube 333 is combined with the top junction 31, the short jaws 333a that are formed in the inner circumference of the sealing tube 333 pressurize the other side of the bottom tube 335, and thus one side of the bottom tube 335 comes into contact with the other side of the inner junction 32. Accordingly, the bottom tube 335 maintains the state in which the bottom tube 335 has been fixed without being moved within the sealing tube 333. The bottom tube 335 surrounds the outside of the clamping tube 332 and protects a portion at which the rivet 331 and the sheath 11 are connected.

The junction sealing member 336 is disposed behind the bottom tube 335 and is pressurized by the sealing tube 333. The junction sealing member 336 may block a fluid so that the fluid is not introduced between the sealing tube 333 and the sheath 11.

An action of the waterproof optic connector is described below.

The fixing unit 20 of the waterproof optic connector 1 is connected to the first member S1 of the socket S that is connected to the signal conversion module. At this time, the connection part 121 of the optical fiber 12 is connected to the end part of the first member S1. At this time, the top junction 31 is separated from the ratchet part 21 by the elastic force of the elastic part 40, and is trapped at the flange 222.

In order to combine the second member S2 disposed outside the connection part 33 and the top junction 31 with the first member S1, when the second member S2 is moved toward the first member S1, the multiple stages formed in the outer circumference of the top junction 31 are trapped at the inner surface of the second member S2, and thus the top junction 31 may be moved along the second member S2. By the movement of the top junction 31, the inner junction 32 pressurizes the elastic part 40, and the second protection tube 322 is gradually inserted into the first protection tube 223. Accordingly, when the second member S2 and first member S1 of the socket are combined, the coupling force of the socket S is increased because the movable unit 30 is moved along the second member S2.

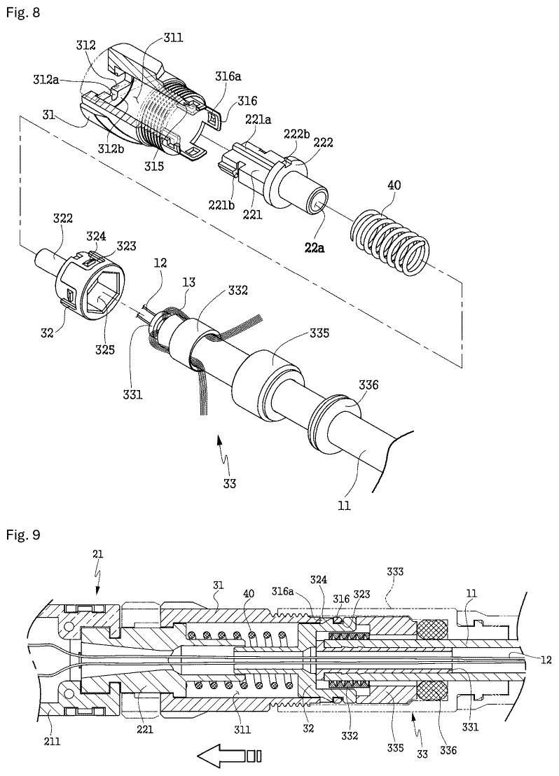

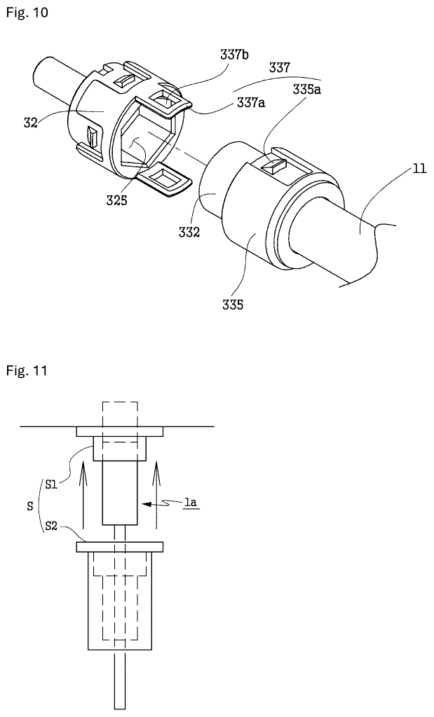

A waterproof optic connector illustrated in FIGS. 8 to 11 according to another embodiment of the present disclosure has most of the components according to the embodiments described with reference to FIGS. 1 to 7. FIG. 8 is a schematic diagram illustrating the waterproof optic connector according to another embodiment of the present disclosure. FIG. 9 is a cut cross-sectional view of the waterproof optic connector of FIG. 8 that has been combined. FIG. 10 is a schematic diagram illustrating a structure in which an inner junction and a bottom tube have been combined. FIG. 11 is a schematic diagram for describing a socket that is combined with a terminal box.

However, in the present embodiment, a guide structure for the top junction 31 and the guide part 22, a structure in which the top junction 31 and the inner junction 32 are combined, and a structure in which the inner junction 32 and the rivet 331 are combined are different from the aforementioned embodiments (refer to FIGS. 8 and 9).

A rail 315 protrudes from the inner circumference of the top junction 31 according to the present embodiment. A rail groove 222b that is combined with the rail 315 is formed in the flange 222. The top junction 31 may move in a straight line by the guide groove 312, the rail groove and the rail that are formed in the guide body 221, and the rail and the rail groove that are formed in the top junction 31 and the flange 222.

Furthermore, combination wings 316 in each of which trapping grooves 316a have been formed protrudes from the other side of the top junction 31. The combination wings 316 are arranged in the circumferential direction of the top junction 31.

A plurality of arrangement grooves 323 into which the combination wings 316 are inserted is formed in the outer circumference of the inner junction 32 at intervals in the circumferential direction thereof. Furthermore, a trapping jaw 324 that is trapped at the trapping groove 316a of the combination wing 316 protrudes from the arrangement groove 323. The top junction 31 and the inner junction 32 are combined so that they are separable from each other by the combination of the combination wing 316 and the trapping jaw 324.

An accommodation groove 325 is formed within the inner junction 32 on the other side thereof. The circumference of the accommodation groove 325 is formed in a polygon shape. The circumference of the accommodation groove 325 may be formed in a circular shape. Furthermore, the rivet 331 is separated from the inner junction 32. A clamping tube 332 that combines the rivet 331 and the sheath 11 is inserted into the accommodation groove 325 and combined therewith. In this case, the outer circumference of the clamping tube 332 is formed identically with the circumference of the accommodation groove 325.

The sealing tube 333 that is combined with the top junction 31 pressurizes the bottom tube 335 toward the inner junction 32. The bottom tube 335 pressurizes the clamping tube 332 so that the rivet 331 maintains the state in which the rivet 331 comes into contact with the internal surface of the accommodation groove 325. The top junction 31 is not moved by the pressurization of the sealing tube 333.

The components of the embodiments of FIGS. 1 to 7 may be applied to other components of the waterproof optic connector of FIGS. 8 to 11 without any change.

Still another embodiment of the present disclosure has most of the components of the embodiments described with reference to FIGS. 1 to 7. Referring to FIG. 10, the inner junction 32 and the bottom tube 335 are combined with a gap by a bottom combination part 337. The gap may be offset by the sealing tube 333 that is combined with the top junction 31.

The bottom combination part 337 includes combination wings 337a which each protrude from the inner junction 32 and are disposed in a circumferential direction thereof and in each of which a trapping groove 337b has been formed, and trapping jaws 335a that are formed in the outer circumference of the bottom tube 335. A part of the bottom tube 335 in which the trapping jaw 335a has been formed is depressed, and is formed in the form of a curved surface so that the combination wing 337a is seated in the curved surface.

As the trapping groove 337b is trapped at the trapping jaw 335a, the combination wing 337a is combined with the bottom combination part 337. In this case, the trapping jaw 335a is combined with the trapping groove 337b with a gap. Accordingly, the bottom tube 335 may be moved within the range of the gap. The location of the bottom combination part 337 can be easily adjusted depending on the location of the clamping tube 332 by the gap. The sealing tube 333 that is combined with the top junction 31 pressurizes the bottom tube 335 toward the inner junction 32. The bottom tube 335 is fixed between an internal short jaw of the sealing tube 333 and the inner junction 32 and thus is not moved.

The components of the embodiments of FIGS. 1 to 7 may be applied to other components of the waterproof optic connector of FIG. 10 without any change.

The embodiments of the disclosure in which an exclusive property or privilege is claimed are defined as follows:

1. A waterproof optic connector comprising:
a fixing unit in which a connection part connected to a first member of a socket is disposed;
a movable unit that is combined with a part of the fixing unit and that is movable; and
an elastic part that applies an elastic force to the movable unit so that the movable unit becomes distant from the first member,
wherein the fixing unit comprises:
a ratchet part in which a connection part is disposed, and
a guide part that protrudes in a direction opposite to a direction of the connection part from the ratchet part and with which the movable unit is movably combined, and
wherein the movable unit has a location set by moving in a straight line toward the first member by a pressurization of the second member combined with the first member,
a travel gear space through which an optical fiber passes is formed in the ratchet part between the guide part and the connection part, and
an optical fiber passage connected to the travel gear space is formed within the guide part.

2. The waterproof optic connector of claim 1, wherein:
a seated groove in which the guide part is separably disposed is formed in the ratchet part, and
the fixing unit further comprises a binding part that prevents a movement of the guide part by binding the guide part with the ratchet part.

3. The waterproof optic connector of claim 1, wherein the guide part comprises:
a guide body that protrudes from the ratchet part, and
a flange formed in an outer circumference of the guide body and separated from the ratchet part,
wherein a cross section of the optical fiber passage is increased toward the ratchet part on the basis of the flange.

4. The waterproof optic connector of claim 3, wherein the movable unit comprises:
a top junction that is combined with the guide body so that the top junction moves in a straight line and that is trapped at the flange, and
an inner junction that is combined with the top junction and faces the flange and an inside of which is penetrated,
wherein the movable unit is movable in a straight line between the flange and the ratchet part, and
the elastic part is disposed between the flange and the inner junction and applies the elastic force so that the top junction is trapped at the flange.

5. The waterproof optic connector of claim 4, wherein:
a guide groove through which the guide body penetrates is formed in the top junction in a polygon shape, and
a rail and a rail groove that provide guidance to a movement of the top junction in a straight line are formed in the guide body and a circumference of the guide groove.

6. The waterproof optic connector of claim 5, wherein:
an outer circumference of the flange comes into contact with an inner circumference of the top junction,
a part of each of the outer circumference of the flange and the inner circumference of the top junction comprises a plane, and
the plane provides guidance to the movement of the top junction in the straight line.

7. The waterproof optic connector of claim 6, further comprising:
a sheath that protects the movable unit and the optical fiber connected to the connection part, and
a connection part that is combined with the top junction.

8. The waterproof optic connector of claim 7, wherein the connection part comprises:
a rivet that is inserted into the sheath from the inner junction,
a clamping tube that surrounds and combines the sheath and the rivet,
a sealing tube that is connected to the top junction and that surrounds and protects a connection portion of the rivet and the sheath, and
a boot that is combined with the sealing tube and that surrounds the sheath.

9. The waterproof optic connector of claim 8, wherein the connection part further comprises:
a bottom tube that is closely attached to the inner junction and the clamping tube by a pressurization of the sealing tube within the sealing tube, and
a junction sealing member that is disposed between an inner circumference of the sealing tube and an outer circumference of the sheath.

10. The waterproof optic connector of claim 9, wherein:
the connection part further comprises a bottom combination part that combines the bottom tube and the inner junction with a gap, and
the gap enables the sealing tube to be offset by the combination of the top junction, so that the bottom combination part is closely attached to the clamping tube.

11. The waterproof optic connector of claim 8, wherein the movable unit further comprises:
a first protection tube that protrudes from the guide body toward the inner junction, and
a second protection tube that protrudes from the inner junction toward the first protection tube and that is connected to the first protection tube,
wherein the optical fiber of the sheath passes through an inside of the guide body, through the second protection tube and an inside of the first protection tube.

12. A waterproof optic connector comprising:
a fixing unit in which a connection part connected to a first member of a socket is disposed;
a movable unit that is combined with a part of the fixing unit and that is movable; and
an elastic part that applies an elastic force to the movable unit so that the movable unit becomes distant from the first member,
wherein the movable unit comprises:
a top junction that is combined and trapped at the fixing unit so that the top junction is movable in a straight line, and
an inner junction that is combined with the top junction and an inside of which is penetrated, and
wherein the movable unit is movable in a straight line in a guide body of the fixing unit,
the elastic part applies the elastic force to the top junction so that the top junction is trapped at the fixing unit, and
the movable unit has a location set by moving in a straight line toward the first member by a pressurization of the second member that is combined with the first member.
